(19) United States
(12) Patent Application Publication
(10) Pub. No.: US 2004/0190095 A1
(43) Pub. Date: Sep. 30, 2004

(54) Optical recording medium and optical recording method

(75) Inventors: Jiro Minabe, Ashigarakami-gun (JP); Katsunori Kawano, Ashigarakami-gun (JP); Tatsuya Maruyama, Ashigarakami-gun (JP); Shin Yasuda, Ashigarakami-gun (JP); Norie Matsui, Ashigarakami-gun (JP); Tsutomu Ishii, Ebina-shi (JP); Kazuhiro Hama, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/659,389

(22) Filed: Sep. 11, 2003

(30) Foreign Application Priority Data
Mar. 24, 2003 (JP) 2003-081292

(51) Int. Cl. G03H 1/16; G03H 1/04

(52) U.S. Cl. 359/29; 359/35

(57) ABSTRACT

In a recording layer, a recording track is provided in the form of concentric circles or a spiral along a moving direction of a recording spot. When only specific Fourier transform components in a Fourier transform image of signal light are recorded, a width of the recording track provided in the recording layer is set corresponding to a diffraction order of the Fourier transform component to be recorded. That is to say, according to the diffraction order of the Fourier transform component to be recorded, the width of the recording track is determined within the range satisfying the following relationship. Here w is the width of the recording track, d is a length of one side of one-bit data of the signal light, λ is a wavelength of the signal light, F is a focal distance of a lens system, and n is an integer of 2, 3, or 4.

$$\frac{λ F}{d} \leq w \leq \frac{n λ F}{d}$$

### CROSS-REFERENCE TO RELATED APPLICATION

This application claims priority under 35 USC 119 from Japanese Patent Application No. 2003-081292, the disclosure of which is incorporated by reference herein.

### BACKGROUND OF THE INVENTION

1. Field of the Invention

The present invention relates to an optical recording medium and an optical recording method, and particularly relates to an optical recording medium which records a hologram and an optical recording method for recording the hologram in the optical recording medium.

2. Description of the Related Art

Holographic memory receives attention as computer memory of the next generation. The holographic memory has both large recording capacity from three-dimensional recording and high speed from two-dimensional reading. By using the holographic memory, data of a plurality of pages can be recorded with the data multiplexed in the same volume, and the data can be collectively read in each page. In the holographic memory, instead of an analog image, digital image processing is carried out to record and reproduce the image in the hologram. The binary digital data “0” and “1” are converted into “bright” and “dark” to record and reproduce the digital data.

Shift multiplexing with spherical reference waves is well known in a multiple recording method of the holographic memory (see the specification of U.S. Pat. No. 5,671,073; D. Psaltis, M. Levene, A. Pu, G. Barbastathis, and K. Curtis, OPTICS LETTERS Vol. 20, No. 7 (1995) p782; and G. Barbastathis, M. Levene, and D. Psaltis, “Shift multiplexing with spherical reference waves”, Appl. Opt. Vol. 35 (1996) p2403). In the method, reference light is formed to be the spherical wave and an optical recording medium is moved relatively to an optical recording head. Thus, another hologram is recorded under conditions that are different from a Bragg condition of the hologram which has been already recorded. As shown in the above-described references, a moving distance of the shift multiplexing recording with the spherical reference wave, i.e., a distance (amount of shift in scanning direction) δ_{spherical} in which holograms can be independently separated from each other and reproduced is expressed by the following equation (1);

$$\begin{matrix}{δ}_{spherical} = {δ}_{Bragg} + {δ}_{NA} \\ \approx ( {λz}_{o} / L tan {θ}_{s} ) + λ / ( 2 ( NA ) )\end{matrix} \qquad ( 1 )$$

wherein λ is a wavelength of signal light, zₒ is a distance between a focal point of an objective lens forming the spherical reference wave and a center of a thickness of a recording layer in the recording medium, L is the thickness of the recording medium, θₛ is a crossed axes angle between the signal light and the spherical reference wave, and NA is a numerical aperture of the objective lens.

However, there is a problem in the shift multiplexing. That is to say, crosstalk is easily generated between tracks arranged in a direction crossed at right angles with the scanning direction in the reproducing, though the hologram multiplexed in the scanning direction can be reproduced with high selectivity.

When a track pitch is increased, though the crosstalk is prevented, the recording capacity is decreased. Accordingly, in order to increase the recording capacity, it is necessary to efficiently arrange the recording tracks while the problem of the crosstalk between the tracks is considered.

In view of the foregoing, it is an object of the invention to provide an optical recording medium and an optical recording method, in which while the crosstalk in the direction crossed at right angles with the scanning direction is prevented, the maximum recording capacity can be obtained, when the recording of the hologram is carried out.

### SUMMARY OF THE INVENTION

In order to achieve the above-described object, a first aspect of the present invention provides an optical recording method comprising: forming a recording spot by selectively using from a zero-order diffracted light component to a low-order diffracted light component of a Fourier transform image of a signal light, in the case where the recording spot is formed by intersecting reference light over signal light in which at least one of amplitude, a phase, and a polarization state has been spatially modulated according to information and the Fourier transform has been carried out with a lens system, the recording spot is scanned, and the hologram is recorded in a recording layer in an optical recording medium, the recording spot is scanned, and the hologram is recorded in a recording layer of the optical recording medium; setting a width of a plurality of recording tracks, which are arranged in a direction crossed at right angles with a scanning direction of the recording spot in the recording layer, according to the order of the diffracted light component so as to be larger than spread of the Fourier transform image corresponding to a maximum spatial frequency of at least the signal light; and scanning the recording spot along the recording track.

In order to achieve the above-described object, a second aspect of the invention provides an optical recording medium which is used for an optical recording method including the steps of modulating spatially at least one of amplitude, a phase, and a polarization state according to information, carrying out a Fourier transform with a lens system, forming a recording spot by intersecting the signal light with a reference light to selectively use diffracted light components having a plurality of orders in a Fourier transform image of the signal light, scanning the recording spot, and recording a hologram in a recording layer of an optical recording medium, a plurality of recording tracks are arranged in a direction crossed at right angles with a scanning direction of a recording spot in the recording layer and a width of the recording track is set according to the order of the diffracted light component so as to be larger than a spread of the Fourier transform image corresponding to a maximum spatial frequency of at least the signal light.

In the optical recording method and the optical recording medium of the invention, when the Fourier transform component to be recorded is limited to the diffracted light components from the zero-order to the low-order, the width of the recording track is set according to the order of the diffracted light component so as to be larger than the spread of the Fourier transform image corresponding to the maximum spatial frequency of at least the signal light. Since a recording region (hologram to be recorded) becomes smaller when the Fourier transform component to be recorded is limited, a width w of the recording track can be decreased according to a diameter of the recording region. An overlap of the recording region can be prevented by substantially equalizing the width w of the recording track to the diameter of the recording region. Consequently, while the generation of the crosstalk is prevented, the maximum recording capacity can be realized.

In the above-described invention, a width w of the recording track may be a value in the following range;

$$\frac{λ F}{d} \leq w \leq \frac{n λ F}{d}$$

wherein d is a length of one side of one-bit data in the signal light, λ is a wavelength of the signal light, F is a focal distance of a lens system, and n is an integer of 2, 3, or 4.

For example, the width w of the recording track may be the following value;

$$w \approx m \frac{λ F}{d}$$

wherein d is the length of one side of one-bit data in the signal light, λ is the wavelength of the signal light, F is the focal distance of the lens system, and m is the integer of 1, 2, 3, or 4.

In the optical recording medium, a surface on a lens side of the recording layer is arranged forward by y from the focal position of the lens system, the width w of the recording track may be provided so as to satisfy the following equation;

$$w \approx m ( \frac{λ F}{d} + \vert \frac{1}{2 F} - \frac{λ}{d} \vert y )$$

wherein d is the length of one side of one-bit data in the signal light, λ is the wavelength of the signal light, F is the focal distance of the lens system, y is the distance between the focal point of the lens system and the surface on the lens side of the recording layer, 1 is a size corresponding to the direction crossed at right angles with the scanning direction of image data before Fourier transform of the signal light, and m is the integer of 1, 2, 3, or 4.

Further, in order to achieve the above-described object, a third aspect of the invention provides an optical recording method which records a hologram in a recording layer of an optical recording medium having a recording track, comprising generating signal light in which at least one of amplitude, a phase, and a polarization state is spatially modulated according to information, carrying out a Fourier transform to the signal light, forming a recording spot in such a manner that the signal light and reference light intersect and diffracted light components having a plurality of orders including a zero-order in a Fourier transform image of the signal light are selectively used, setting a width of the recording tracks according to the order of the diffracted light component so as to be larger than a spread of the Fourier transform image corresponding to a maximum spatial frequency of at least the signal light, and scanning the recording spot along the recording track.

### BRIEF DESCRIPTION OF THE DRAWINGS

FIG. 1 is a schematic diagram for explaining shift multiplexing.

FIG. 2 shows an example of a data image recorded in a hologram.

FIG. 3 shows a Fourier transform image of the data image shown in FIG. 2.

FIG. 4 is a perspective view showing an appearance of an optical recording medium of the present invention.

FIG. 5 is a sectional view showing an example of a layer structure of the optical recording medium of the present invention.

FIG. 6 is a schematic diagram showing an arrangement of a recording track.

FIG. 7 is a sectional view along an optical axis showing a spread of primary diffracted light in the case where a recording layer is arranged in front of a focal position.

### DETAILED DESCRIPTION OF THE INVENTION

An embodiment of the present invention will be described below referring to the accompanying drawings.

(Shift Multiplexing)

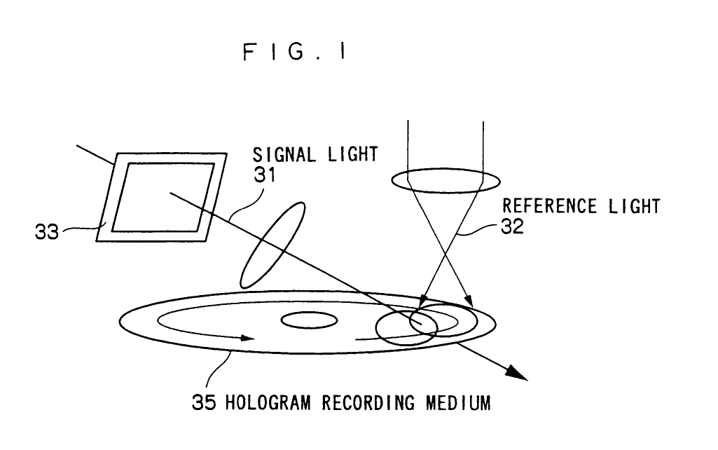

In shift multiplexing, as shown in FIG. 1, signal light 31 spatially modulated according to information to be recorded with a spatial light modulator 33 and reference light 32 are simultaneously incident to an optical recording medium 35. The spherical wave is used as the reference light 32. The plurality of holograms is overwritten in the same region by rotating the disk-shaped optical recording medium 35. For example, a wavelength of the recording/reproducing light in a vacuum is set to 532 nm, a distance between the focal point of spherical reference wave and the center of the thickness of the recording layer is set to 2 mm, a refractive index of the recording medium is to 1.5, the thickness of the recording layer is set to 1 mm, a crossed axes angle between the signal light and the reference light in the medium is set to 40°, and a numerical aperture of a lens forming the spherical reference wave is set to 0.5. In this case, another hologram can be recorded in the substantially same region without generating a crosstalk only in a manner that the optical recording medium 35 is moved by 1.7 μm. Since the reference light 32 is the spherical wave, it is utilized that the movement of the disk 35 is equal to a change in the angle of the reference light 32.

(Fraunhofer Diffraction Pattern)

In order to more effectively increase the recording capacity in the shift multiplexing, it is desirable to minutely divide the recording region. Volume multiple recording of higher density can be realized by carrying out the multiple recording in the minute region. For this purpose, in the holographic memory system, the Fourier transform is applied to the signal light with the lens and the recording medium is irradiated with the signal light. In the case that the image of the signal light has a fine pitch (high spatial frequency), Fraunhofer diffraction of the signal light occurs on the surface of the recording medium and a spread (of the diffraction image is expressed by the following equation (2);

ζ=kλFωx (2)

In the above equation, k is a constant of proportion, λ is the wavelength of the signal light, F is a focal distance of a lens for Fourier transform, and ωx is the spatial frequency of the signal light.

Accordingly, when the lens having the small focal distance F is used as the lens for the Fourier transform, the recording region can be minutely divided. This is shown, e.g. in Chapter 7 of “Holography” (the Institute of Electronics, Information, and Communication Engineers, Japan). Further, by arranging the aperture in front of the recording medium, the unnecessary spread of the signal light and the reference light can be limited and the recording region can be minutely divided.

(Fourier Transform Component Required for Data Reproducing)

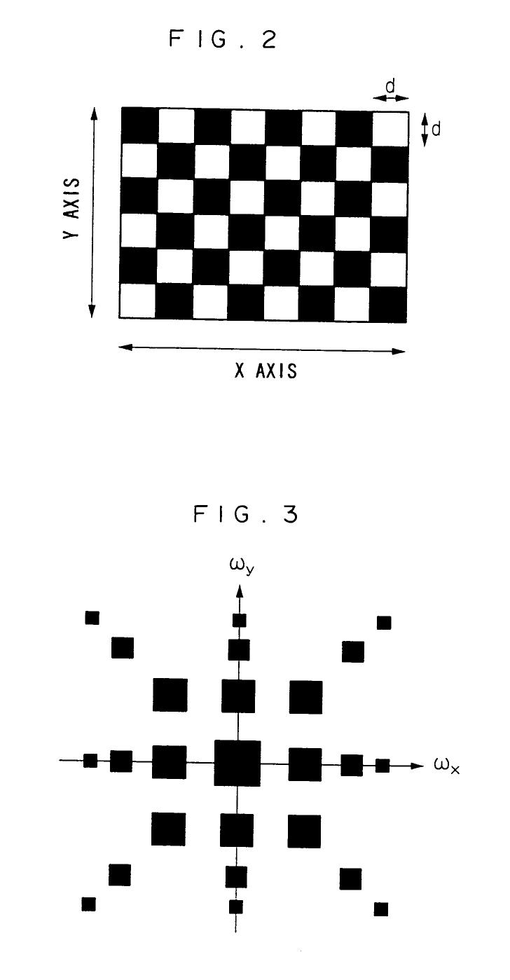

It is assumed that the data of a page recorded as a hologram is, e.g. the image shown in FIG. 2. The binary two-dimensional digital data can be recorded in each page in such a manner that a white portion in the figure indicates data of “1” and a black portion indicates data of “0”. In this case, one pixel of d×d corresponds to one-bit data.

In the case that such a data image is recorded as a hologram, in order to improve the recording density and to cause the hologram to have shift invariant properties, the Fraunhofer diffraction image of the data image is recorded by using lens. Since the Fraunhofer diffraction image is proportional to the Fourier transform of an amplitude distribution of the data image shown in FIG. 2, it is also referred to as Fourier transform hologram. FIG. 3 shows the Fourier transform image of the data image shown in FIG. 2. This can be obtained from the above-described equation (2).

In order to densely record the digital data, it is required to cram the bit data within one page as much as possible by decreasing the area of one pixel of the data image shown in FIG. 2, i.e., decreasing the value of d. Accordingly, in addition to the high-density recording, high-speed recording/reproducing can be realized.

However, when the area of one pixel is decreased, the Fourier transform image of the data image of the signal light is spread according to the equation (2) on the optical recording medium. This is because the spatial frequency ωx proportional to 1/d is increased as the data image of the signal light becomes finer, i.e., the value of d becomes small. The spread of the Fourier transform image prevents the high-density recording.

All components of the Fourier transform image shown in FIG. 3 are not necessary for the data reproducing. The spread in an x-axis direction of the Fourier transform image shown in FIG. 3 corresponds to the spatial frequency ωx in the x-axis direction of the data image shown in FIG. 2. For the x-axis direction, the Fourier transform image is symmetrically spread from zero-order light (ωx=0) as center toward a plus direction and a minus direction. A y-axis direction is also similar to the x-axis direction. Thus, the spatial frequency has the plus and minus values, however, one of the sign components may be required in order to reproduce the data image of the signal light.

Further, since the Fourier transform image of the signal light contains many spatial frequency components derived from the shape and the pitch of the pixel of the signal light, even if a harmonic component is cut, the signal light can be reproduced without error. This will be described below. When the spatial frequency of the image data is a properly normalized value from the beginning, the Fraunhofer diffraction image shown in FIG. 3 becomes the Fourier transform image itself of the signal light. In the equation (2), k becomes 1, and the spread ζ of the Fraunhofer diffraction image is expressed by the following equation (3).

ζ=λFωx (3)

Substituting a specific numerical example, a trial calculation is carried out to the spread ζ of the diffraction image. For example, in the case where the wavelength λ is 500 nm, the focal distance f is 10 cm, and the spatial frequency ωx is 25 lines/mm (corresponding to the pixel of 40 μm×40 μm), the spread ζ of the diffraction image becomes 1.25 mm. Combining the plus component and the minus component, the spread ζ of the diffraction image becomes 2.5 mm. As shown in FIG. 3, the diffraction image becomes a discontinuous and periodic pattern with an interval of 1.25 mm.

From the above description, in the Fourier transform image of the signal light, when the Fourier transform components having the spread ζ from the zero-order light defined by the following equation (4) are recorded, the image data can be reproduced;

0≦ζ≦nFλ/d (4)

wherein n is 1, 2, or 3.

Though the recording region can be minimized when only the zero-order component of the Fourier transform image is recorded, loss of the data is likely to be generated and the data image of the signal light can not be read out. In order not to generate the loss of the data, it is necessary to record at least the zero-order and primary components of the Fourier transform image. When the recording is carried out up to the high-order component such as the quaternary or quaternary component of the Fourier transform image, the data image of the signal light can be read out with high S/N. However, the minimization can not be sufficiently carried out in the recording region and the recording capacity is not sufficiently increased. Actually, reading error is hardly generated in the reproducing when the recording is carried out up to the primary component of the Fourier transform image. Further, the data image of the signal light can be read out with sufficiently high S/N when the recording is carried out up to the secondary or tertiary component of the Fourier transform image.

In order to record/reproduce the specific Fourier transform components, as shown in Japanese Patent Application Laid-Open (JP-A) No. 2000-66565, a shielding body in which a light transmitting portion transmitting only the specific Fourier transform component is formed may be arranged in front of the optical recording medium.

(Structure of Optical Recording Medium)

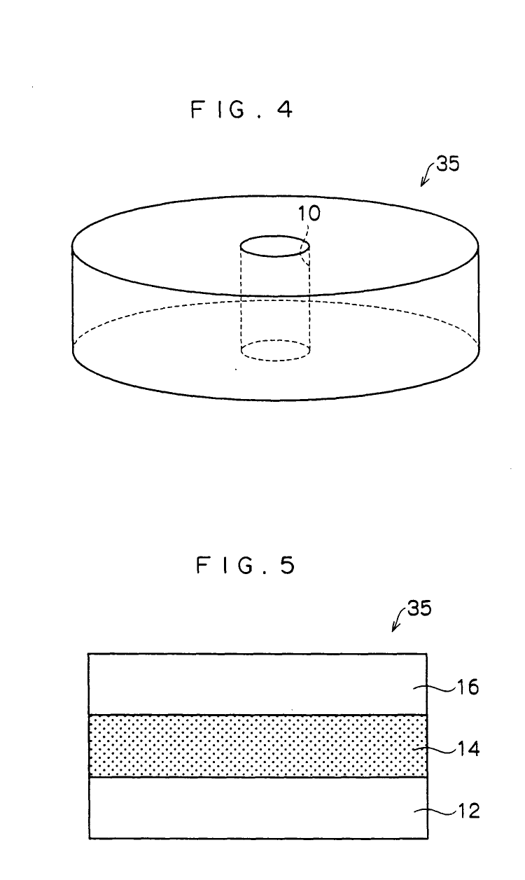

As shown in FIG. 4, the optical recording medium 35 of the present invention is the disk-shaped recording medium of which a center hole 10 is formed at a central portion. As shown in FIG. 5, a transparent substrate 12, a recording layer 14, and a protective layer 16 protecting the recording layer 14 are laminated in this order in the optical recording medium 35 of the present invention.

A quartz substrate, a glass substrate, and a plastic substrate can be used as the transparent substrate 12. Here “transparent” means that a material is transparent to the recording light and the reproducing light. For example, polycarbonate; acrylic resin such as polymethyl methacrylate; vinyl chloride resin such as polyvinyl chloride and vinyl chloride copolymer; epoxy resin; amorphous polyolefin; and polyester can be cited as the material of the plastic substrate. From points of humidity resistance, dimensional stability, price, and the like, polycarbonate is particularly preferable. Though the thickness of the transparent substrate 12 is not particularly limited, it is preferable that the thickness is in the range of 0.1 to 2 mm in order to hold the shape of the disk.

A guide groove for tracking, or concavities and convexities (pre-groove), which indicate information such as an address signal, are formed in the transparent substrate 12. It is preferable that the grooves define a width of the track.

In the recording layer 14, the hologram can be recorded by changing the refractive index or an absorption coefficient. The recording layer 14 may be formed by any material in which the changed refractive index or absorption coefficient is held at room temperature. A photosensitive material showing optically induced birefringence is cited as a preferable material for the recording layer 14. The photosensitive material showing the optically induced birefringence can sense a polarization state of the incident light and record a polarization direction of the incident light. The optical recording medium which can record the hologram by the optically induced birefringence corresponding to a polarization distribution is referred to as polarization sensitive.

Polymer or polymer liquid crystal having a photoisomerizing group in a side chain, or polymer in which isomerizing molecules are dispersed is particularly preferable for the material showing the optically induced birefringence. For example, the material containing an azobenzene skeleton is preferable for the photoisomerizing group or molecule.

A principle of the optically induced birefringence will be described here taking azobenzene as an example. As shown in the following chemical formula, azobenzene shows the photoisomerization of trans-cis by the irradiation of the light. Before the irradiation of the light onto the optical recording layer, trans-azobenzene is dominant in the optical recording layer. These molecules are randomly oriented and isotropic from the macroscopic viewpoint. When the optical recording layer is irradiated with the linearly polarized light from a predetermined direction shown by an arrow, trans 1-azobenzene having an absorption axis in the same orientation as the polarization direction of the light is selectively photoisomerized into cis-azobenzene. The molecule relaxed into trans 2-azobenzene having the absorption axis crossed at right angles with the polarization direction does not absorb the light any more and is fixed at the state of trans 2-azobenzene. As a result, from the macroscopic viewpoint, anisotropy of an absorption coefficient and the refractive index, i.e., dichroism and the birefringence are induced. These characteristics are generally referred to as optically induced birefringence, optically induced dichroism, or optically induced anisotropy. The induced anisotropy can be erased by irradiating azobenzene with circularly polarized light or unpolarized light.

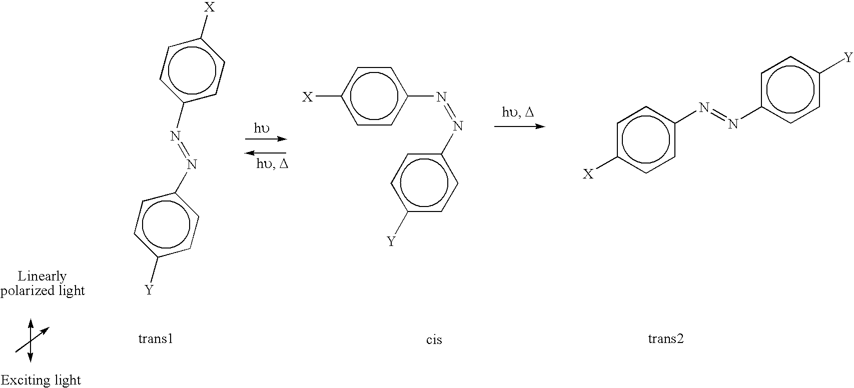

In polymer containing the photoisomerizing group, the orientation of the polymer itself can be changed by the photoisomerization to induce the large birefringence. The induced birefringence is stable below the glass transition temperature of polymer and preferable for the recording of the hologram.

Polyester having azobenzene in its side chain shown by the following Chemical Formula (1) (hereinafter referred to as “azopolymer”) can be cited as a preferable example of the material constituting the recording layer 14. This polyester can record intensity and polarization direction of the signal light as a hologram by the optically induced anisotropy caused by the photoisomerization of azobenzene in the side chain. Polyester having cyanoazobenzene in its side chain is particularly preferable among azopolymers (“Holographic recording and retrieval of polarized light by use of polyester containing cyanoazobenzene units in the side chain”, K. Kawano, T. Ishii, J. Minabe, T. Niitsu, Y. Nishikata and K. Baba, Opt. Lett. Vol. 24 (1999) pp.1269-1271);

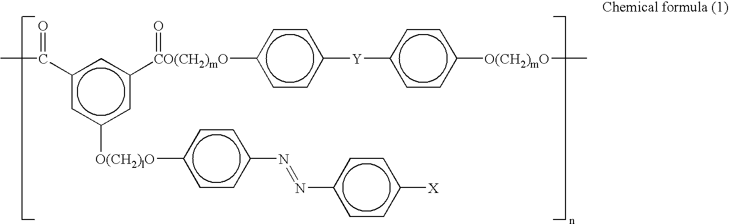

In the above formula, X indicates a cyano group, a methyl group, a methoxy group, or a nitro group and Y indicates a bivalent linkage group having ether linkage, ketone linkage, or sulfone linkage. 1 and m indicate the integer from 2 to 18, more preferably the integer from 4 to 10, and n indicates the integer from 5 to 500, more preferably the integer from 10 to 100.

The recording layer 14 can be formed, e.g., in such a manner that the material of the recording layer is dissolved in a solvent to carry out spin-coating or casting on the transparent substrate 12. The recording layer 14 may be also formed by hot pressing. The thickness of the recording layer 14 is preferably in the range of 0.1 mm to 2 mm.

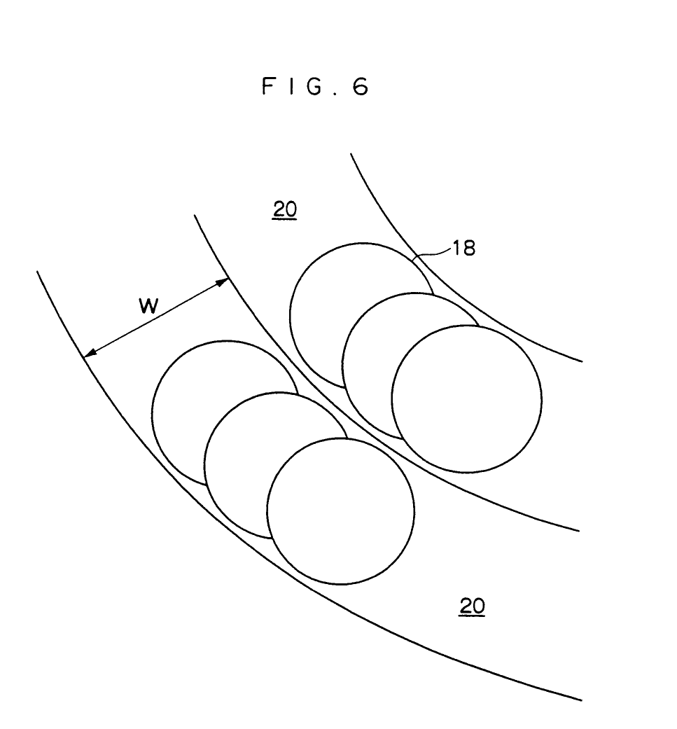

As shown in FIG. 6, in the recording layer 14, a recording track 20 is provided in the shape of a concentric circle or a spiral along a moving direction of a recording spot 18. A width w of the recording track 20 is described later. Adjacent recording tracks 20 can be separated by a region where at least one of optical transmittance, reflectivity, and optical anisotropy is different from that of the track region. By sensing the region with probe light which is proper for tracking guide, accuracy of position of the tracking can be improved and data transfer can be realized at high speed. When the amount of recording information of each hologram to be recorded is increased, it is necessary that the reproduced diffracted light is incident to a predetermined position of a photodetector with high accuracy. Accordingly, it is important to improve the accuracy of position of the tracking.

The protective layer 16 is provided in order to improve flaw resistance and the humidity resistance of the optical recording medium and the like. For example, inorganic materials such as SiO, SiO₂, MgF₂, SnO₂, and Si₃N₄ and organic materials such as thermoplastic resin, thermosetting resin, and photocurable resin can be cited as the material used for the protective layer. The protective layer can be formed by laminating a film obtained by extrusion of plastic on a light reflecting layer through a bonding agent. Alternatively the protective layer may be provided by vacuum evaporation, sputtering, coating, or the like. In the case of the thermoplastic resin or thermosetting resin, the protective layer can be also formed in such a manner that after the thermoplastic resin or thermosetting resin is dissolved in a proper solvent to prepare a coating solution, the coating solution is applied and dried. In the case of the photocurable resin, the protective layer can be also formed in such a manner that a coating solution is prepared only by using the photocurable resin itself or by dissolving the photocurable resin in a proper solvent, and then the coating solution is applied and irradiated with UV light to cure. Further, various kinds of additives such as an antistatic agent, an anti-oxidizing agent, UV absorber may be added in the coating solution depending on purpose. Similarly to the transparent substrate 12, the thickness of the protective layer 16 is not particularly limited. However, it is preferable that the thickness of the protective layer 16 is in the range of 0.1 μm to 2 mm.

(Width of Recording Track)

As described above, there is the case in which only the specific Fourier transform components within the Fourier transform image of the signal light are recorded. In the present embodiment, the width w of the recording track 20 provided in the recording layer 14 is set corresponding to diffraction order of the Fourier transform component to be recorded. However, it is necessary that the width w of the recording track is at least larger than the spread ζ of the diffraction image corresponding to the maximum spatial frequency of the signal light modulated spatially. That is to say, according to the diffraction order of the Fourier transform component to be recorded, the width w of the recording track is determined within the range satisfying a relationship of the following equation (5);

$$\frac{λ F}{d} \leq w \leq \frac{n λ F}{d} \qquad ( 5 )$$

In the above equation, d is a length of one side of one-bit data in the signal light, λ is the wavelength of the signal light, F is a focal distance of the lens system, and n is an integer of 2, 3, or 4. “The length of one side of one-bit data in the signal light” corresponds to “the length of one side of one pixel in the spatial light modulator” in the case where the signal light is spatially modulated with the spatial light modulator.

For example, in the case where the zero-order and primary components of the Fourier transform image are recorded, the width w of the recording track is set to λF/d. In the case that the zero-order through secondary components of the Fourier transform image are recorded, the width w of the recording track is set to 2λF/d. In the case that the zero-order through tertiary components of the Fourier transform image are recorded, the width w of the recording track is set to 3λF/d. In the case that the zero-order through quaternary components of the Fourier transform image are recorded, the width w of the recording track is set to 4λF/d.

In the case that the Fourier transform components to be recorded are limited to the components from the zero-order to the low-order, since the recording region (hologram to be recorded) is small, the width w of the recording track can be decreased according to the diameter of the recording region. In the case that the recording is carried out up to the n-order Fourier transform component, the diameter of the recording region is nλF/d. An overlap of the recording region can be prevented by substantially equalizing the width w of the recording track to the diameter of the recording region. Consequently, while the generation of the crosstalk is prevented, the maximum recording capacity can be realized.

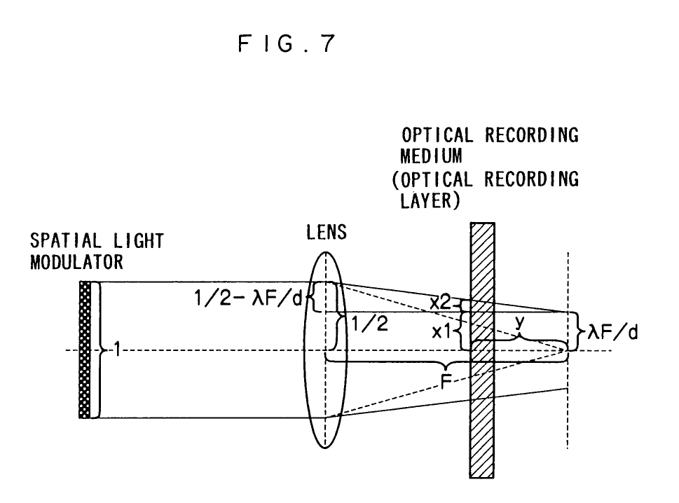

In the Fourier transform image of the signal light, the light intensity of the zero-order Fourier transform component is stronger and nonuniformity of the light intensity is larger in the recording spot. Accordingly, as shown in FIG. 7, it is preferable that the recording layer is arranged in front of or at the back of the focal position in order to keep balance with the light intensity of the reference light. Keeping the balance between the light intensity of the signal light and that of the reference light achieves an effect that a hologram having higher contrast of modulation amplitude can be formed.

When the recording layer is arranged forward by y from the focal position, a spread (x1+x2) of the primary component (primary diffracted light) is expressed by the following equation (6).

$$x2 = \vert \frac{1}{2} - \frac{F λ}{d} \vert \frac{y}{F} , \\ so that \\ x1 + x2 = \frac{F λ}{d} + \vert \frac{1}{2} - \frac{F λ}{d} \vert \frac{y}{F} \qquad ( 6 )$$

Accordingly, the spread ζ from the zero-order light to m-order light on the surface of the recording layer is expressed by the following equation (7).

$$ζ = m ( \frac{F λ}{d} + \vert \frac{1}{2 F} - \frac{λ}{d} \vert y ) \qquad ( 7 )$$

As described above, in the case where the recording layer is arranged forward by y from the focal position, the width w of the recording track 20 provided in the recording layer 14 is set so as to satisfy the following equation (8);

$$w \approx m ( \frac{ λ F}{d} + \vert \frac{l}{2 F} - \frac{λ}{d} \vert y ) \qquad ( 8 )$$

In the above equation, y is the distance between the focal position of the lens system and the surface on the lens side of the optical recording layer, l is the size corresponding to the direction crossed at right angles with the scanning direction of the image data before Fourier transform of the signal light, and m is an integer of 1, 2, 3, or 4.

As described above, in the embodiment, according to the signal light components to be recorded, the width w of the recording track is set to the minimal required width in order to prevent the overlap of the recording regions, so that the crosstalk can be prevented in the direction crossed at right angles with the scanning direction and the maximum recording capacity can be realized. That is to say, in the case where the recording of the hologram is carried out, the hologram can be effectively recorded in the optical recording medium.

The region where at least one of the optical transmittance, the reflectivity, and optical anisotropy is different from that of the track region can be provided between the recording tracks and used as the tracking guide. The accuracy of position of the tracking can be improved and the data transfer can be realized at high speed.

The effect of the optical recording medium and optical recording method of the present invention is not limited to the shift multiplexing using the spherical reference wave. For example, the present invention is effective to any recording/reproducing method scanning the recording spot, such as a method in which after the multiple recording is carried out by angle multiplexing in which the angle of the reference light is changed at a certain recording spot, the recording spot is scanned to achieve the next angle multiplexing, as well as the recording in which the multiplexing is not carried out.

Though the example in which the optical recording medium is disk-shaped is described in the embodiment, the shape of the optical recording medium is not limited to the disk shape. For example, the shape of the optical recording medium can be formed in the shape of a card.

Further, though the example in which the recording track is provided in the form of the concentric circle or the spiral is described in the embodiment, the recording track may be provided according to the scanning method. For example, the recording track can be formed in linear-shaped.

What is claimed is:

1. An optical recording method for recording a hologram, wherein a recording spot is formed by intersecting reference light with signal light in which at least one of amplitude, a phase, and a polarization state has been spatially modulated according to information and a Fourier transform has been carried out with a lens system, the recording spot is scanned, and the hologram is recorded in a recording layer in an optical recording medium, the method comprising:
forming the recording spot by selectively using zero-order to low-order diffracted light components of a Fourier transform image of the signal light;
setting a width of a plurality of recording tracks, which are arranged in a direction crossed at right angles with a scanning direction of the recording spot in the recording layer, according to the order of the diffracted light component so as to be at least larger than a spread of the Fourier transform image corresponding to a maximum spatial frequency of the signal light; and
scanning the recording spot along the recording track.

2. An optical recording method according to claim 1, wherein a width w of the recording track satisfies a relationship expressed by the following equation:
$$\frac{λ F}{d} \leq w \leq \frac{n λ F}{d}$$
wherein d is a length of one side of one-bit data in the signal light, λ is a wavelength of the signal light, F is a focal distance of the lens system, and n is an integer of 2, 3, or 4.

3. An optical recording method according to claim 1, wherein a width w of the recording track satisfies a relationship expressed by the following equation:
$$w \approx m \frac{λ F}{d}$$
wherein d is a length of one side of one-bit data in the signal light, λ is a wavelength of the signal light, F is a focal distance of the lens system, and n is an integer of 1, 2, 3, or 4.

4. An optical recording method according to claim 1, wherein a width w of the recording track satisfies a relationship expressed by the following equation in the case where, in the optical recording medium, a surface on a lens side of the recording layer is arranged forward by y from a focal position of the lens system:
$$w \approx m ( \frac{λ F}{d} + \vert \frac{1}{2 F} - \frac{λ}{d} \vert y )$$
wherein d is a length of one side of one-bit data in the signal light, λ is a wavelength of the signal light, F is a focal distance of the lens system, y is a distance between the focal point of the lens system and the surface on the lens side of the recording layer, 1 is a size, of image data before Fourier transform of the signal light, corresponding to the direction crossed at right angles with the scanning direction, and m is an integer of 1, 2, 3, or 4.

5. An optical recording method for recording a hologram in a recording layer of an optical recording medium having a recording track, the method comprising:
generating signal light in which at least one of amplitude, a phase, and a polarization state is spatially modulated according to information;
carrying out a Fourier transform to the signal light;
forming a recording spot in such a manner that the signal light and reference light intersect and diffracted light components, of the signal light, having a plurality of orders including a zero-order in a Fourier transform image are selectively used;
setting a width of the recording track according to the order of the diffracted light component so as to be at least larger than a spread of the Fourier transform image corresponding to a maximum spatial frequency of the signal light; and
scanning the recording spot along the recording track.

6. An optical recording method according to claim 5, wherein a plurality of the recording tracks are arranged in a direction crossed at right angles with a scanning direction of the recording spot in the recording layer.

7. An optical recording method according to claim 5, wherein the Fourier transform is applied to the signal light by using a lens system.

8. An optical recording method according to claim 5, wherein the reference light is a spherical reference wave and a hologram is multiply recorded by shift multiplexing.

9. An optical recording medium which is used for an optical recording method including the steps of modulating spatially at least one of amplitude, a phase, and a polarization state of signal light according to information, carrying out a Fourier transform with a lens system, forming a recording spot by intersecting the signal light with a reference light to selectively use diffracted light components, of the signal light, having a plurality of orders in a Fourier transform image, scanning the recording spot, and recording a hologram in a recording layer of the optical recording medium, wherein
a plurality of recording tracks are arranged in a direction crossed at right angles with a scanning direction of the recording spot in the recording layer; and
widths of the recording tracks are set according to the order of the diffracted light component so as to be at least larger than a spread of the Fourier transform image corresponding to a maximum spatial frequency of the signal light.

10. An optical recording medium according to claim 9, wherein the orders of the diffracted light components in the Fourier transform image are one of zero-order and primary, zero-order through secondary, zero-order through tertiary, or zero-order through quaternary.

11. An optical recording medium according to claim 9, wherein a width w of the recording track satisfies a relationship expressed by the following equation;
$$\frac{λ F}{d} \leq w \leq \frac{n λ F}{d}$$
wherein d is a length of one side of one-bit data in the signal light, λ is a wavelength of the signal light, F is a focal distance of the lens system, and n is an integer of 2, 3, or 4.

12. An optical recording medium according to claim 9, wherein a width w of the recording track satisfies a relationship expressed by the following equation:
$$w \approx m \frac{λ F}{d}$$
wherein d is a length of one side of one-bit data in the signal light, λ is a wavelength of the signal light, F is a focal distance of the lens system, and m is an integer of 1, 2, 3, or 4.

13. An optical recording medium according to claim 9, wherein a width w of the recording track satisfies a relationship expressed by the following equation in the case where, in the optical recording medium, a surface on a lens side of the recording layer is arranged forward by y from a focal position of the lens system:
$$w \approx m ( \frac{λ F}{d} + \vert \frac{1}{2 F} - \frac{λ}{d} \vert y )$$
wherein d is a length of one side of one-bit data in the signal light, λ is a wavelength of the signal light, F is a focal distance of the lens system, y is a distance between the focal point of the lens system and the surface on the lens side of the recording layer, 1 is a size, of image data before a Fourier transform of the signal light, corresponding to the direction crossed at right angles with the scanning direction, and m is an integer of 1, 2, 3, or 4.

14. An optical recording medium according to claim 9, wherein the plurality of recording tracks are arranged adjacent to each other and separated by a region where at least one of optical transmittance, reflectivity, and optical anisotropy is different from that of the recording track region.

15. An optical recording medium according to claim 9, wherein the plurality of recording tracks are provided in the form of concentric circles.

16. An optical recording medium according to claim 9, wherein the plurality of recording tracks are provided in the form of a spiral.

17. An optical recording medium according to claim 9, wherein the optical recording medium is substantially in the form of a disk.

18. An optical recording medium according to claim 9, wherein the optical recording medium is substantially in the form of a card.
